(19) United States
(12) Patent Application Publication
(10) Pub. No.: US 2022/0226683 A1
(43) Pub. Date: Jul. 21, 2022

(54) SPRINKLER HEAD PROTECTIVE CASE DEVICE AND SYSTEM

(71) Applicants: Mark Stephen Ouellette, Chester, VT (US); Carol Ann Leofanti, Chester, VT (US)

(72) Inventors: Mark Stephen Ouellette, Chester, VT (US); Carol Ann Leofanti, Chester, VT (US)

(21) Appl. No.: 17/648,348

(22) Filed: Jan. 19, 2022

Related U.S. Application Data
(60) Provisional application No. 63/139,103, filed on Jan. 19, 2021.
(60) Provisional application No. 63/163,260, filed on Mar. 19, 2021.
(60) Provisional application No. 63/211,360, filed on Jun. 16, 2021.

(51) Int. Cl. A62C 35/68; B05B 15/18; A62C 31/02

(52) U.S. Cl. CPC A62C 35/68; A62C 31/02; B05B 15/18

(57) ABSTRACT

Various sprinkler head protective case devices are disclosed. These devices provide substantial physical protection to sprinkler heads from accidental damage and/or activation thereof during temporary periods of construction and maintenance. The devices include fire and heat resistant shells that selectively close to surround the sprinkler head and open to permit removal therefrom. Cushioning pads are provided for more stable assemblies, and the shells can be locked into place so that the protective case devices do not accidentally become dislodged.

### CROSS-REFERENCE TO RELATED APPLICATION

This application claims the benefit of priority of U.S. provisional application No. 63/139,103, filed Jan. 19, 2021, U.S. provisional application No. 63/163,260, filed Mar. 19, 2021, and U.S. provisional application No. 63/211,360, filed Jun. 16, 2021, the contents of which are herein incorporated by reference.

### BACKGROUND OF THE INVENTION

The present invention relates to sprinkler heads and, more particularly, to a protective case to prevent damage to sprinkler heads.

At the present, accidental damage and/or activation of sprinkler heads can occur during temporary periods of construction, reconstruction, renovation, remodeling and demolition of a building, as well as while temporary active work is being performed by, for example, electricians, plumbers, carpenters, maintenance workers and general laborers. A secondary problem of these aforementioned activities is the negative impact dust, smoke, ash and construction-related heat can have in relation to sprinkler head performance when activated in a real-time fire emergency.

Conventional solutions are insufficient to address these issues. For example, painter cups do not offer adequate physical protection from accidental damage and or activation due to physical contact. Additionally, sprinkler head shipping clips do not provide adequate or reliable protection to the overall sprinkler head.

As can be seen, there is a need for a sprinkler head protective case. The sprinkler head protective cases, described herein and variants in accordance with the present invention, offer total physical protection to sprinkler heads from accidental damage and/or activation during temporary periods of construction and maintenance.

### SUMMARY OF THE INVENTION

In one aspect of the present invention, a protective case device configured for use with a fire sprinkler head is disclosed, the protective case device including: a first case shell half; a second case shell half hingedly coupled to the first case shell half such that the first case shell half and the second case shell half are movable between an open position and a closed position, the first case shell half and the second case shell half being shaped to substantially cover the fire sprinkler head in the closed position; a first cushioning pad configured to be interposed between the first case shell half and the first sprinkler head in the closed position; a second cushioning pad configured to be interposed between the second case shell half and the first sprinkler head in the closed position; and a locking mechanism for selectively maintaining the first case shell half and the second case shell half in the closed position.

In another aspect of the present invention, a fire sprinkler head protection system is disclosed and includes: a pipe; a fire sprinkler coupled to the pipe and comprising a fire sprinkler head; a protective case device for the fire sprinkler head, the device including: a first case shell half; a second case shell half hingedly coupled to the first case shell half such that the first case shell half and the second case shell half are movable between an open position and a closed position, the first case shell half and the second case shell half being shaped to substantially cover the fire sprinkler head in the closed position; a first cushioning pad interposed between the first case shell half and the first sprinkler head in the closed position; a second cushioning pad interposed between the second case shell half and the first sprinkler head in the closed position; and a locking mechanism for selectively maintaining the first case shell half and the second case shell half in the closed position.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in use with a sprinkler head;

FIG. 2 is an exploded view of the embodiment of the present invention;

FIG. 3 is a section view of the embodiment of the present invention, taken along line 3-3 in FIG. 1, with the sprinkler components shown in full for clarity;

FIG. 4 is a section view of the embodiment of the present invention, taken along line 4-4 in FIG. 3;

FIG. 5: is a section view of the embodiment of the present invention, similar to FIG. 4, illustrating the opening of a case shell half;

FIG. 6 is a section view of the embodiment of the present invention, illustrating the removal of the embodiment from the sprinkler head;

FIG. 7 is a perspective view of an alternate embodiment of the present invention, shown in use with another sprinkler head;

FIG. 8 is an exploded view of the alternate embodiment of the present invention of FIG. 7;

FIG. 9 is a section view of the embodiment of the present invention of FIG. 7, taken along line 9-9 in FIG. 7;

FIG. 10 is a perspective view of another alternate embodiment of the invention, shown in use with a sprinkler head;

FIG. 11 is a section view of the embodiment of the present invention of FIG. 10, taken along line 11-11 in FIG. 10;

FIG. 12 is a perspective view of yet another alternate embodiment of the present invention, shown in use with a sprinkler head; and

FIG. 13 is a section view of the embodiment of the present invention of FIG. 12, taken along line 13-13 in FIG. 12.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, embodiments of the present invention include devices, a system, and a method for protecting sprinkler heads from accidental damage and activation.

As stated above, the sprinkler head protective case of the present invention solves the problem of accidental damage and or activation of sprinkler heads during temporary periods of construction, reconstruction, renovation, remodeling, and demolition as well as temporary active work performed by electricians, plumbers, carpenters, maintenance workers and general laborers. It also eliminates the negative impact that dust, smoke, ash, and construction-related heat can have in relation to sprinkler head performance when activated in a real-time fire emergency. Embodiments of the present invention may be used to protect various configurations of sprinkler heads, including, but not limited to, straight, elbow, tee-bone, and ceiling-wall mount sprinkler heads.

The claimed invention differs and is a clear improvement from what currently exists. The sprinkler head protective cases of the present invention provide 100% physical coverage and protection to sprinkler heads during temporary periods of construction and or maintenance. No other the devices in this field exist. Previous devices/systems were not created to offer 100 percent physical protection to sprinkler heads during active periods of construction and maintenance. As mentioned above, painter's cups protect the sprinkler heads from contact with paint, but they do not offer adequate physical protection to sprinkler heads if accidental contact is made. Shipping clips were created to attempt to protect sprinkler head bulbs during shipping but are not reliable.

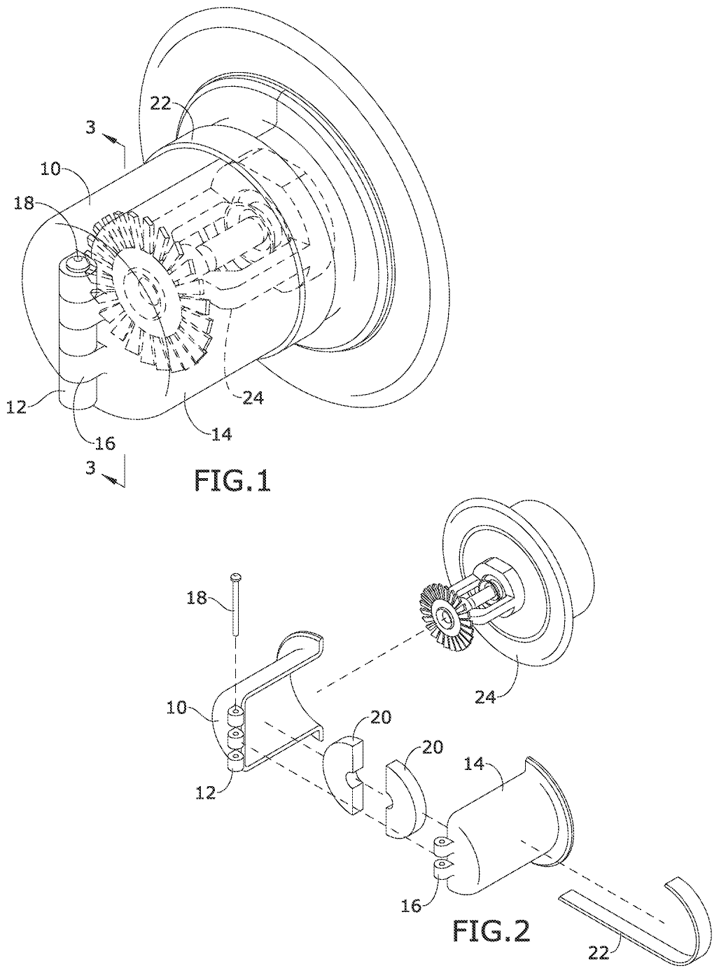

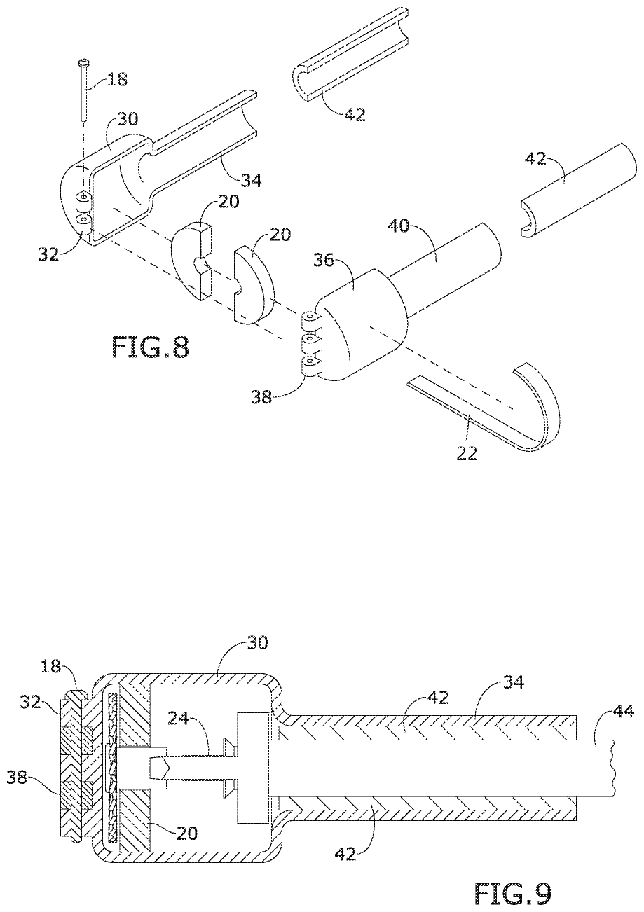

Referring now to FIGS. 1-13, numerous specific details are set forth in the following description in order to provide a thorough understanding of the invention. However, the invention may be practiced according to the claims without some or all of these specific details. For the purpose of clarity, technical material that is known in the technical fields related to the present invention has not been described in detail so that the present invention is not unnecessarily obscured.

The present disclosure contemplates four exemplary embodiments of the present invention: a straight protective case device, an elbow protective case device, a tee-bone protective case device, and a ceiling and wall mount protective case device, as these are the four most common types of sprinkler heads. Those with skill in the art will appreciate that other variations of sprinkler head type are envisaged, and protective cases associated therewith are in accordance with the present invention. These embodiments all generally include: (1) a protective case shaped to cover a particular sprinkler head type, (2) interior insulating and stabilizing foam pads, and (3) a locking mechanism (embodied as a locking strap) for securing the protective case in a closed position (which may be coupled to the case, for example, by one or more rivets). Depending on the sprinkler head to be covered/protected, additional stabilizing foam pads may be provided.

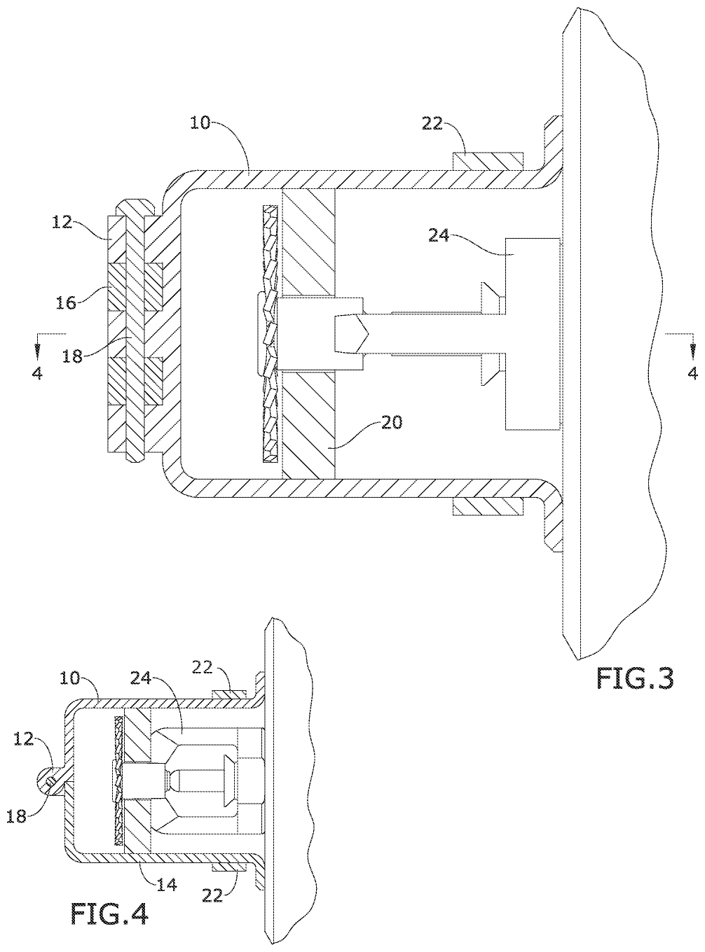

Referring now to FIGS. 1-6, a ceiling and wall mount sprinkler head protective case device is shown. This assembly is configured to couple to a ceiling or wall sprinkler head assembly 24 (where a water pipe is hidden behind the ceiling or wall). The ceiling and wall mount sprinkler head protective case device includes a first shell half 10 and a second shell half 14 hingedly coupled together. In certain embodiments, the hinged coupling may be constituted by first half hinge knuckles 12 and second half hinge knucks 16 that are rotatably coupled together via a hinge pin 18. However, those with skill in the art will appreciate that other hinge types may be used in accordance with the present invention. As shown, the shell halves 10, 14 are shaped to substantially cover a sprinkler head of the sprinkler head assembly 24. In use, they define a secure chamber in which the sprinkler head is disposed (e.g., see FIGS. 3 and 4). The ceiling and wall mount sprinkler head protective case device further includes sprinkler head cushioning/insulating pads 20 and a locking strap 22 for securing the shell halves 10, 14 in a closed position (e.g., see FIG. 1).

In certain embodiments, the pads 20 may be made from foam. As shown, the pads 20 may be formed in semi-cylindrical shapes, attached to inner surfaces of the shell halves 10, 14, and include small notches to receive a sprinkler head portion of the sprinkler head assembly. The pads 20 serve multiple purposes, including providing insulation against heat, positioning the shell halves 10, 14 around the sprinkler head assembly 24 (increasing stability of the device's connection to the sprinkler head assembly 24), and absorbing any forces imparted to the shell halves 10, 14 by, for example, accidental bumps thereto.

In certain embodiments, the locking strap 22 may be permanently attached to one of the shell halves 10, 14 (via, for example, riveting), and wrapped around the halves 10, 14 and coupled back to itself via a hook and loop fastener arrangement. However, those with skill in the art will appreciate that other connections may be used with the strap such that it secures the shell halves 10, 14 in a closed position around the sprinkler head assembly 24. As shown, it may be disposed on a side of the shell halves 10, 14 opposite the hinge structure to more effectively maintain the halves 10, 14 in the locked position.

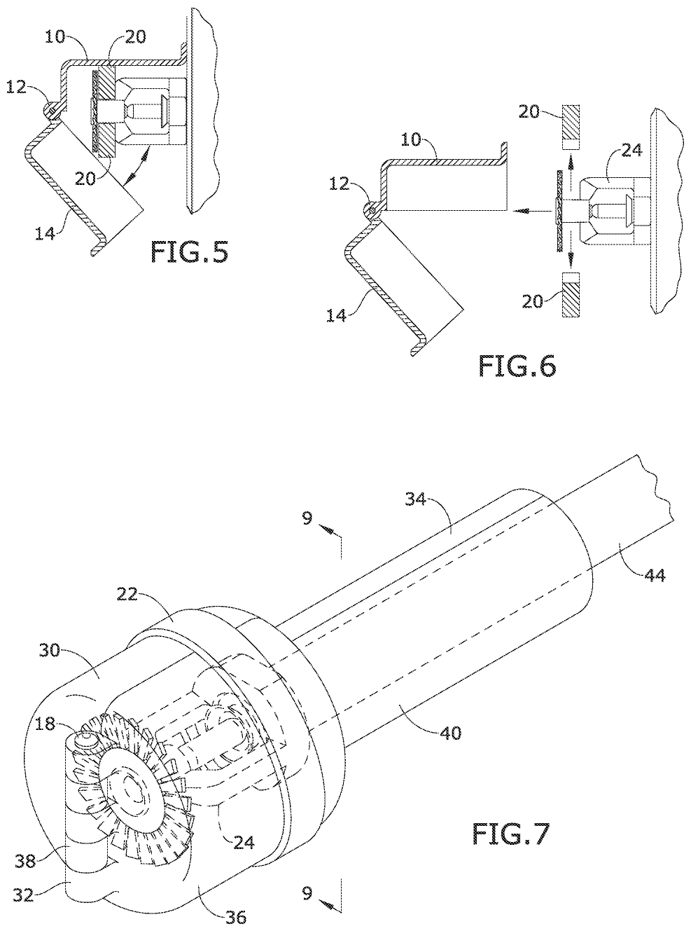

In use, the ceiling and wall mount sprinkler head protective case device can be employed in scenarios described above, such as, but not limited to, when construction or maintenance is going on and accidental damage or activation of the sprinkler head is more likely. As shown in FIG. 6, the pads 20 may be moved in the opposite direction of the arrows shown to next with a neck portion of the sprinkler head assembly 24, proximal the sprinkler head itself. After this occurs, and as shown in FIG. 5, the shell halves 10, 14 may be positioned over the sprinkler head assembly 24 such that the halves 10, 14 will abut the wall, ceiling, or a base of the sprinkler head assembly when closed. It will also be appreciated that, in other embodiments, the pads 20 may be adhered to inner surfaces of the shell halves 10, 14, rather than being provided as entirely separate components.

As shown in FIG. 4, the shell halves 10, 14 are then pivoted closed, and the locking strap 20 may be wrapped around the shell halves 10, 14 and secured to lock the protective case device in position. In certain embodiments, the foam pads 20 may be formed slightly larger than a spacing between the inner walls of the halves 10, 14 and the neck portion of the sprinkler head assembly 24 such that a compression fit is formed between the sprinkler head assembly 24 and the protective case device. Thus, the protective case device is securely maintained in place, and the sprinkler head assembly 24 is protected. To remove, the reverse steps may be employed.

FIGS. 6-13 illustrate alternative embodiments of the present invention. The functionality of all of them is substantially the same as that of the embodiment of FIGS. 1-5. Consequently, only brief descriptions are provided, with any differences noted, as appropriate.

FIGS. 7-9 illustrate a straight protective case device for use with a sprinkler head assembly 24 that terminates at the end of a straight pipe 44. This straight protective case device includes case shell halves 30, 36, hinge knuckles 32, 38, a hinge pin 18, foam pads 20, and a locking strap 22 all functioning in a similar manner as the previously described embodiment. In addition to the case shell halves 30, 36 that are positioned proximal the sprinkler head in use, a first shell half extension 34 and a second shell half extension 40 may be provided that encloses a straight portion of the pipe 44, providing even further stability and protection for the protective case device. Further, pipe cushions 42 may be provided around the pipe 44 in use, in a similar manner as the pads 20 previously described, resulting in an even more stable and protected final assembly.

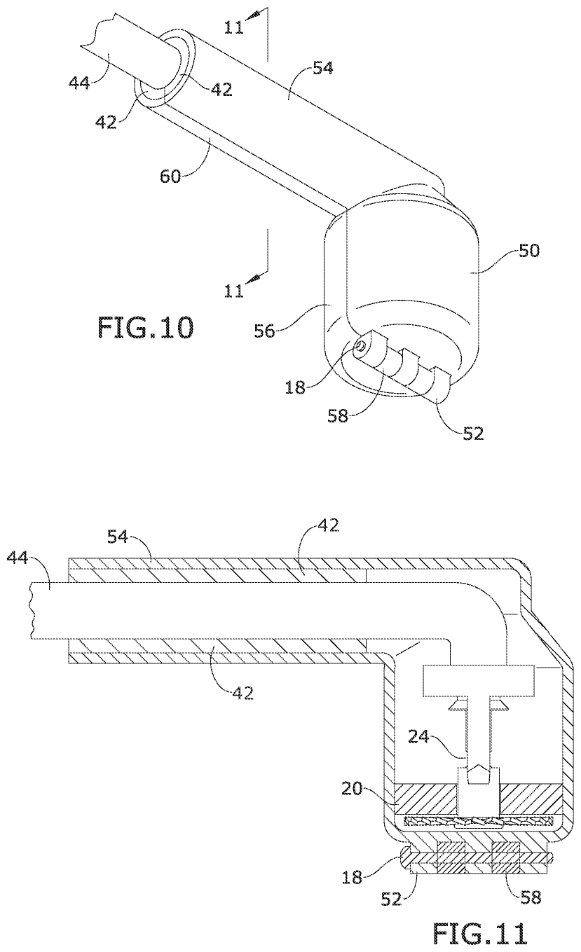

FIGS. 10-11 illustrate an elbow protective case device for use with a sprinkler head assembly 24 that terminates at an elbow (i.e., a pipe 44 that has a 90 degree bend at its end). This elbow protective case device includes case shell halves 50, 56, hinge knuckles 52, 58, a hinge pin 18, foam pads 20, and a locking strip 22, all functioning in a similar manner as the previously described embodiments. In addition to the case shell halves 50, 56 that are positioned proximal the sprinkler head in use, a first shell half extension 54 and a second shell half extension 60 may be provided that encloses the elbow portion of the pipe 44, providing even further stability and protection for the protective case device. Further, pipe cushions 42 may be provided around the pipe 44 in use, in a similar manner as the pads 20 previously described, resulting in an even more stable and protected final assembly.

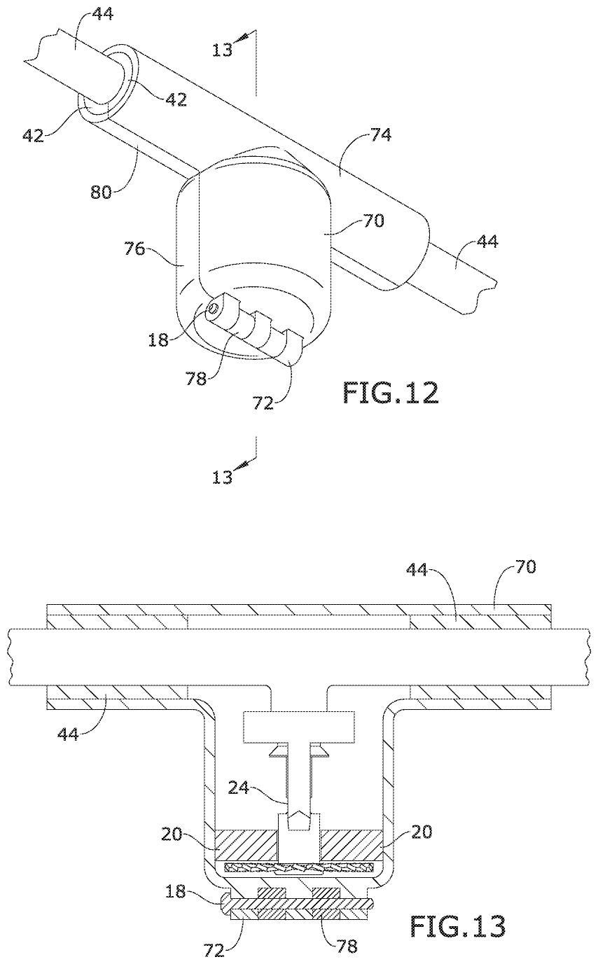

FIGS. 12-13 illustrate a tee-bone protective case device for use with a sprinkler head assembly 24 that is positioned at a T-joint in a pipe 44. This tee-bone protective case device includes case shell halves 70, 76, hinge knuckles 72, 78, a hinge pin 18, foam pads 20, and a locking strip 22, all functioning in a similar manner as the previously described embodiments. In addition to the case shell halves 70, 76 that are positioned proximal the sprinkler head in use, a first shell half extension 74 and a second shell half extension 80 may be provided that encloses the T-section of the pipe 44, providing even further stability and protection for the protective case device. Further, pipe cushions 42 may be provided around the pipe 44 in use, in a similar manner as the pads 20 previously described, resulting in an even more stable and protected final assembly.

In the embodiments of the present invention, the shell pieces may be formed as fire and heat resistant hard plastic bodies. They may be created via plastic injection molding, and formed with hinge structure such that a metal screw or pin can be inserted through the hinge structure. The stabilizing foam pads 20, discussed above, may be glued/adhered to the interior of the shell halves, or may be provided as a separate component and positioned into place when in use (as discussed above). Similarly, in certain embodiments, independent and additional foam pads 42 may be provided to place between the protective device and the pipe 44. These additional pads 42 may also be positioned between the protective device and a wall or ceiling. The exteriors of each protective device may be painted bright orange for visual safety and to better prevent accidental contact. The hook and loop fastener locking straps may be attached at the base of each protective device using, for example, a single rivet.

In other embodiments, an open mesh case could be provided to allow for the protective case device to be left on the sprinkler head after active work periods, thus providing impact protection while still permitting adequate water distribution if activated in a real time fire emergency. Further, those with skill in the art will appreciate that embodiments of the present invention may be reconfigured such that protection for other devices is allowed, such as, but not limited to, technological devices, domestic appliances, machines, tools, mechanical devices, and fragile items.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A protective case device configured for use with a fire sprinkler head, the protective case device comprising:
a first case shell half;
a second case shell half hingedly coupled to the first case shell half such that the first case shell half and the second case shell half are movable between an open position and a closed position, the first case shell half and the second case shell half being shaped to substantially cover the fire sprinkler head in the closed position;
a first cushioning pad configured to be interposed between the first case shell half and the first sprinkler head in the closed position;
a second cushioning pad configured to be interposed between the second case shell half and the first sprinkler head in the closed position; and
a locking mechanism for selectively maintaining the first case shell half and the second case shell half in the closed position.

2. The protective case device of claim 1, wherein the locking mechanism is a locking strap that is secured to the first case shell half and configured to wrap around the first case shell half and the second case shell half in the closed position.

3. The protective case device of claim 2, wherein the locking strap is positioned at an end of the first case shell half opposite the hinged coupling.

4. The protective case device of claim 1, wherein the first cushioning pad and the second cushioning pad each define a notch for receiving a portion of a neck of the fire sprinkler head.

5. The protective case device of claim 1, wherein the first cushioning device is adhered to an inner surface of the first case shell half and the second cushioning device is adhered to an inner surface of the second case shell half.

6. The protective case device of claim 1, wherein the first case shell half and the second case shell half define a chamber that is configured to receive the fire sprinkler head.

7. The protective case device of claim 1, wherein the first case shell half and the second case shell half are formed from fire and heat resistant plastic material.

8. The protective case device of claim 7, wherein the first cushioning pad and the second cushioning pad are formed from a foam material.

9. A fire sprinkler head protection system comprising:
a pipe;
a fire sprinkler coupled to the pipe and comprising a fire sprinkler head;
a protective case device for the fire sprinkler head, the device comprising:
a first case shell half;
a second case shell half hingedly coupled to the first case shell half such that the first case shell half and the second case shell half are movable between an open position and a closed position, the first case shell half and the second case shell half being shaped to substantially cover the fire sprinkler head in the closed position;
a first cushioning pad interposed between the first case shell half and the first sprinkler head in the closed position;
a second cushioning pad interposed between the second case shell half and the first sprinkler head in the closed position; and
a locking mechanism for selectively maintaining the first case shell half and the second case shell half in the closed position.

10. The fire sprinkler head protection system of claim 1, wherein the fire sprinkler is coupled to the pipe at one of: a wall or a ceiling, an elbow joint, a T-joint, or a straight section of the pipe.
